(19) United States
(12) Patent Application Publication
(10) Pub. No.: US 2023/0345073 A1
(43) Pub. Date: Oct. 26, 2023

(54) SYSTEMS AND METHODS FOR PROVIDING AUXILIARY MANIFESTS FOR MEDIA ITEMS

(71) Applicant: META PLATFORMS TECHNOLOGIES, LLC, Menlo Park, CA (US)

(72) Inventor: Colleen Kelly Henry, Oakland, CA (US)

(21) Appl. No.: 17/696,622

(22) Filed: Mar. 16, 2022

(51) Int. Cl. H04N 21/435; H04N 21/84; G06N 20/00; H04N 21/4402; H04N 21/45; H04N 21/81

(52) U.S. Cl. CPC H04N 21/435; H04N 21/84; G06N 20/00; H04N 21/4402; H04N 21/4516; H04N 21/816

(57) ABSTRACT

A computer-implemented method for providing auxiliary manifests for media items may include (i) generating a media manifest for a media item that lists at least one media file that, when played by a media player, plays the media item, (ii) generating an auxiliary manifest for the media item that lists at least one non-media file that cannot be played by the media player to play the media item but facilitates playing the media item, (iii) receiving a request from a client device for the media manifest, and (iv) in response to receiving the request, sending, to the client device, both the media manifest and the auxiliary manifest. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for providing auxiliary manifests for media items.

FIG. 2 is a flow diagram of an exemplary method for providing auxiliary manifests for media items.

FIG. 3 is an illustration of an exemplary media manifest that lists media files with an auxiliary manifest that lists non-media files.

FIG. 4 is an illustration of an exemplary interaction between a server hosting an auxiliary manifest that includes non-media files and a client device.

FIG. 5 is a block diagram of an exemplary interaction between a server hosting an auxiliary manifest and a client that does not support auxiliary manifests.

FIG. 6 is a block diagram of an additional exemplary interaction between a server hosting an auxiliary manifest that includes non-media files and a client device.

FIG. 7 is a block diagram of an exemplary interaction between a server hosting an auxiliary manifest that includes non-media files and multiple client devices.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

When downloading a media item such as a video from a server, a client may be presented with a media manifest that lists the relevant files for playing the media item on the client device. A media manifest may include files of different types, qualities, and/or resolutions, enabling the client to select the files that best fit the client's needs (e.g., optimal resolution for a display on the client, of a type that can be decoded by a codec installed on the client, etc.). A media manifest may be created in accordance with a manifest standard that specifies the types of files that may be included in the media manifest and the format of the list of those files. Currently, media manifests created in accordance with existing standards may include only files intended to be played by a media player to play the media item, such as audio files, video files, and/or subtitles. In some cases, media manifests may also include metadata about media files. The present disclosure is generally directed to systems and methods for creating an auxiliary manifest for a media item that includes non-media files that enhance the ability of a client device to play the media item and that is designed to be sent alongside a traditional media manifest.

The systems described herein may include various types of files in an auxiliary manifest, such as game data files, links to media players, up-to-date codecs, plug-ins, three-dimensional projection data, machine learning model training data, and/or post-processing filters, in order to enable the client device to play the most up-to-date, highest-quality version of the media possible as efficiently as possible. In some embodiments, the systems described herein may include decode complexity metrics in an auxiliary manifest in order to enable the client to select the highest-complexity encoding that the client system is capable of decoding. By listing non-media files in an auxiliary manifest, the systems described herein may enable up-to-date client devices to access relevant non-media files while avoiding sending potentially error-inducing filetypes or other data to legacy client devices that may not gracefully handle non-media files in manifests.

In some embodiments, the systems described herein may improve the functioning of a computing device by improving the ability of the computing device to play media. Additionally, the systems described herein may improve the fields of streaming media and/or manifests by creating auxiliary manifests that include files that enhance the ability of client devices to play streaming and/or downloaded media.

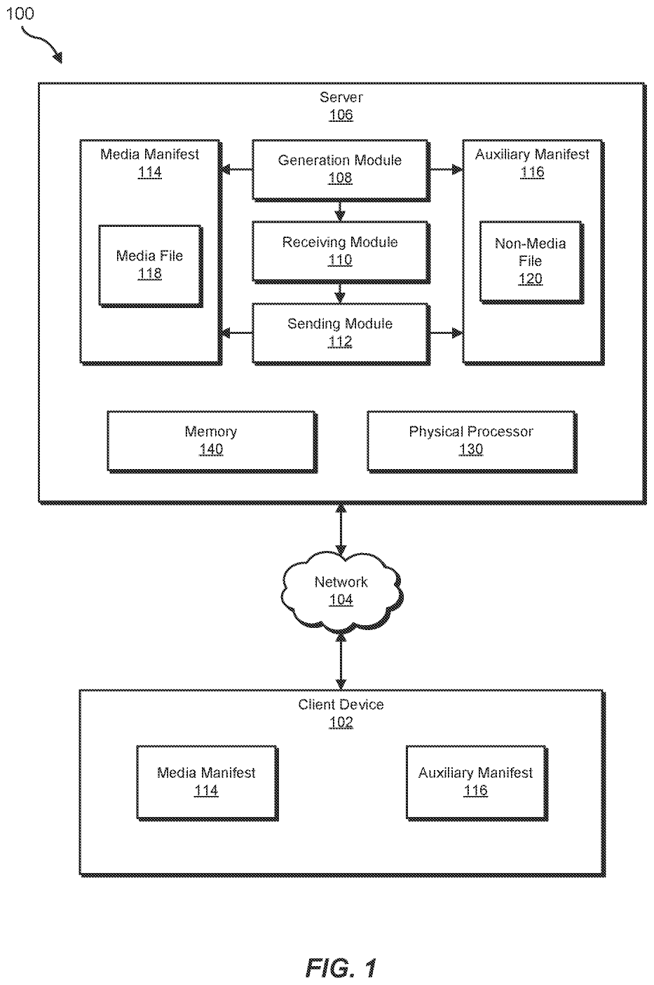

In some embodiments, the systems described herein may provide auxiliary manifests for media items to a client device. FIG. 1 is a block diagram of an exemplary system 100 for providing auxiliary manifests for media items from a server to a client device. In one embodiment, and as will be described in greater detail below, a server 106 may be configured with a generation module 108 that may generate a media manifest 114 for a media item that lists at least one media file 118 that, when played by a media player, plays the media item and/or generate an auxiliary manifest 116 for the media item that lists at least one non-media file 120 that cannot be played by the media player to play the media item but facilitates playing the media item. In some embodiments, generation module 108 may generate one or both manifests in response to receiving a request from the media item. Additionally or alternatively, generation module 108 may pre-generate one or both manifests and, at some later time, a receiving module 110 may receive a request from a client device 102 (e.g., via a network 104) for media manifest 114. In either case, in response to receiving the request, a sending module 112 may send, to client device 102, both media manifest 114 and auxiliary manifest 116.

Server 106 generally represents any type or form of backend computing device that may serve manifests and/or files relevant to media items. Examples of server 106 may include, without limitation, media servers, application servers, database servers, and/or any other relevant type of server. Although illustrated as a single entity in FIG. 1, server 106 may include and/or represent a group of multiple servers that operate in conjunction with one another.

Client device 102 generally represents any type or form of computing device capable of reading computer-executable instructions. For example, client device 102 may represent a personal computing device operated by an end user. Additional examples of client device 102 may include, without limitation, a laptop, a desktop, a tablet, a smart television, a smart projector, a mobile phone, a wearable device, a smart device, an artificial reality device, a personal digital assistant (PDA), etc.

Media manifest 114 generally represents any listing of media files that may be played by a media player to play a media item and that are available for download by a client. In some examples, a media manifest may include details about the media files, such as the locations of the media files. In some embodiments, a media manifest may be created in accordance with a manifest standard that specifies the types of files that may be included in the media manifest and/or the format of the media manifest. For example, a media manifest may be created in accordance with the hypertext transfer protocol (HTTP) live streaming (HLS) standard or the dynamic adaptive dreaming over HTTP (DASH) manifest standard.

Media file 118 generally represents any digital file that, when played by a media player on the client device, plays a media item (e.g., audio and/or video). For example, a media file may be an audio file, a video file, and/or an add-on to an audio or video file such as an enhancement layer for a video file, a subtitle file, and/or any other relevant file designed to be played by a media player.

Auxiliary manifest 116 generally represents any listing of non-media files that enhance the ability of a media player and/or client device to play a media file. In some embodiments, an auxiliary manifest may be created in accordance with a manifest standard for auxiliary manifests.

Non-media file 120 generally represents any digital file that cannot be played by a media player to plays a media item. In some examples, a non-media file may enhance the playback of a media item by a media player in some way. For example, a non-media file may be a media player, installer for a media player, link to download a media player, plug-in for a media player, update for a media player, machine learning model training data for a machine-learning-based media player, post-processing filters for a media item, and/or three-dimensional projection data for a three-dimensional media player. In some examples, a non-media file may enable playback of a media item by an application that is not a media player. For example, model positioning data may enable a game engine or other rendering engine to play back a record of model positions over time (e.g., a recording of events in a game) as a video.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

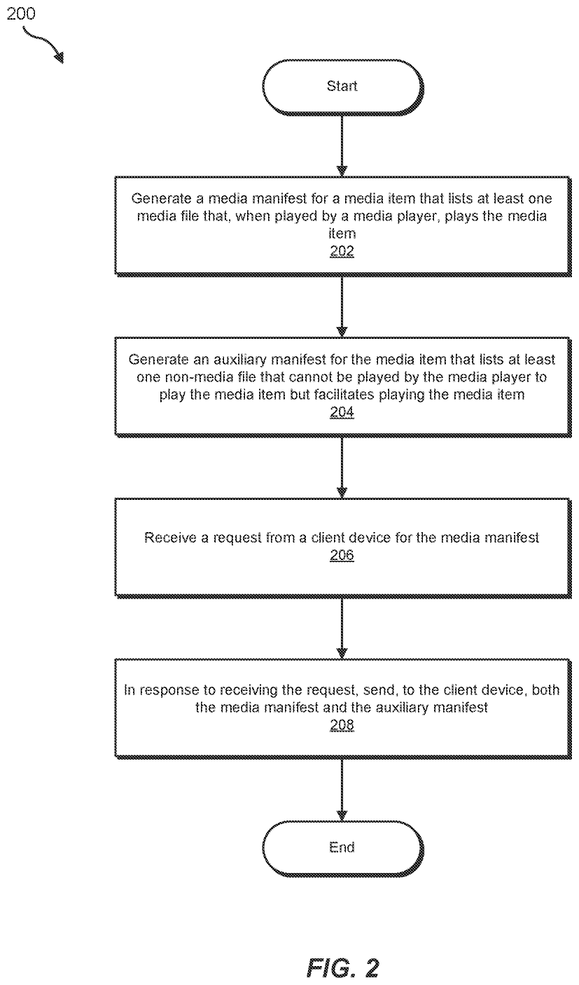

FIG. 2 is a flow diagram of an exemplary method 200 for providing auxiliary manifests for media items. In some examples, at step 202, the systems described herein may generate a media manifest for a media item that lists at least one media file that, when played by a media player, plays the media item. For example, generation module 108 in FIG. 1 may, as part of server 106, generate media manifest 114 for a media item that lists media file 118.

The systems described herein may create a media manifest in a variety of ways and/or contexts. For example, the systems described herein may be installed on a media server that serves audio and/or video to client devices. In one example, the systems described herein may be part of a media service for a social networking platform and may serve media on the social networking platform. In some examples, the systems described herein may identify audio and/or video media items that are available for download and/or streaming by client devices and may create media manifests for the available media items.

In some embodiments, the systems described herein may generate multiple media manifests for the same media item. For example, the systems described herein may create a DASH manifest and an HLS manifest for the same media item. In some examples, the systems described herein may create multiple media manifests that each correspond to a different version of the same manifest standard.

In some examples, at step 204, the systems described herein may generate an auxiliary manifest for the media item that lists at least one non-media file that cannot be played by the media player to play the media item but facilitates playing the media item. For example, generation module 108 in FIG. 1 may, as part of server 106, generate auxiliary manifest 116 for the media item that lists non-media file 120.

The systems described herein may generate auxiliary manifests in a variety of ways and/or contexts. In some embodiments, the systems described herein may generate an auxiliary manifest for every item of media for which the systems described herein generate and/or identify a media manifest. In other embodiments, the systems described herein may only generate an auxiliary manifest for items of media that are flagged (e.g., automatically based on attributes of the media item) as benefiting from non-media files. For example, the systems described herein may not generate auxiliary manifests for short videos with a low file size that can easily be decoded by even legacy codecs and can be played at full quality without any enhancements but may generate auxiliary manifests for three-dimensional media that benefits from projection hints, videos with a large file size that benefit from complexity metrics, and/or videos encoded in newly released codecs that not all clients may have installed.

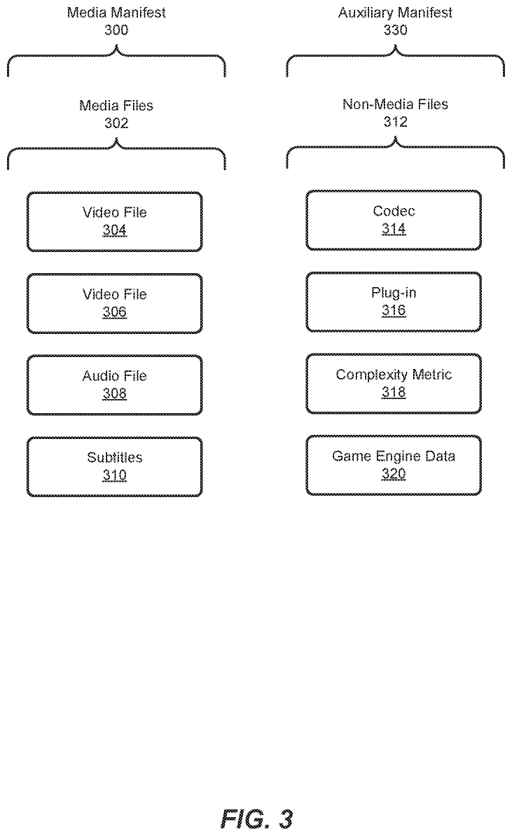

In some examples, the systems described herein may create media manifests that include various types of media files and auxiliary manifests that include various types of non-media files. For example, as illustrated in FIG. 3, the systems described herein may create a media manifest 300 that includes media files 302, such as a video file 304, a video file 306 (e.g., at a different resolution and/or in a different video format), an audio file 308 (e.g., a soundtrack for the video), and/or a subtitles 310. Similarly, the systems described herein may create an auxiliary manifest 330 that includes non-media files 312, such as codec 314 (e.g., to decode video file 304), plug-in 316, complexity metric 318 (e.g., for video file 304), and/or game engine data 320.

In one example, the systems described herein may identify a video and may create a media manifest for the video that includes video files encoded via different codecs at different resolutions as well as an auxiliary manifest that includes a complexity metric for each of the encoded video files in the media manifest. By including a complexity metric for each of the encoded video files, the systems described herein may enable a client to select the file that best fits the client. For example, a client with considerable processing power such as a laptop with a graphical processing unit may select a high-quality video file encoded with a high-complexity codec while a client with less processing power such as a smartphone may select a lower-quality video file encoded with a lower-complexity codec.

In some embodiments, the systems described herein may create auxiliary manifests that include files that enhance the ability of a media player on a client device to play the media item in various different ways. For example, the systems described herein may create an auxiliary manifest that includes projection data for a three-dimensional version of the media item. The projection data may enable a client device capable of playing three-dimensional media (e.g., a three-dimensional projector, a virtual reality headset, etc.) to project the media item more accurately than if the projection data were not included. In another example, the systems described herein may create an auxiliary manifest that includes machine learning model training data for a machine-learning-based media player on the client device. For example, the training data may be tailored to the media item to enable a machine learning model on the media player to more accurately facilitate play of the media item. Additionally or alternatively, the systems described herein may create an auxiliary manifest that includes a post-processing filter to be applied to the media file by the client device. For example, the auxiliary manifest may include a post-processing filter that is tailored to the media item and therefore will produce a higher-quality result when applied to the media item compared to a more generic post-processing filter that may already be installed on the client device (or compared to no post-processing).

Returning to FIG. 2, in some examples, at step 206, the systems described herein may receive a request from a client device for the media manifest. For example, receiving module 110 in FIG. 1 may, as part of server 106, receive a request from client device 102 for media manifest 114.

The systems described herein may receive a request from a client device in a variety of ways and/or contexts. In some embodiments, the systems described herein may be hosted on a remote media server (e.g., in a data center) and may receive a request from a client device in a user's home. Additionally or alternatively, the systems described herein may be hosted on a local media server (e.g., in a user's home) and may receive a request from a client device on the same local network. In some embodiments, the systems described herein may receive a request for a specific media manifest, such as an HLS manifest. Additionally or alternatively, the systems described herein may receive a request for any available manifest. In some examples, the systems described herein may receive a request for both a media manifest and an auxiliary manifest for a media item.

In some examples, at step 208, the systems described herein may, in response to receiving the request, send, to the client device, both the media manifest and the auxiliary manifest. For example, sending module 112 in FIG. 1 may, as part of server 106, send, to client device 102, both media manifest 114 and auxiliary manifest 116.

The systems described herein may send both the media manifest and the auxiliary manifest in a variety of ways and/or contexts. In some embodiments, the systems described herein may transmit both manifests concurrently. Additionally or alternatively, the systems described herein may transmit both manifests consecutively. The systems described herein may send the manifests via any suitable protocol, such as HTTP or file transfer protocol (FTP).

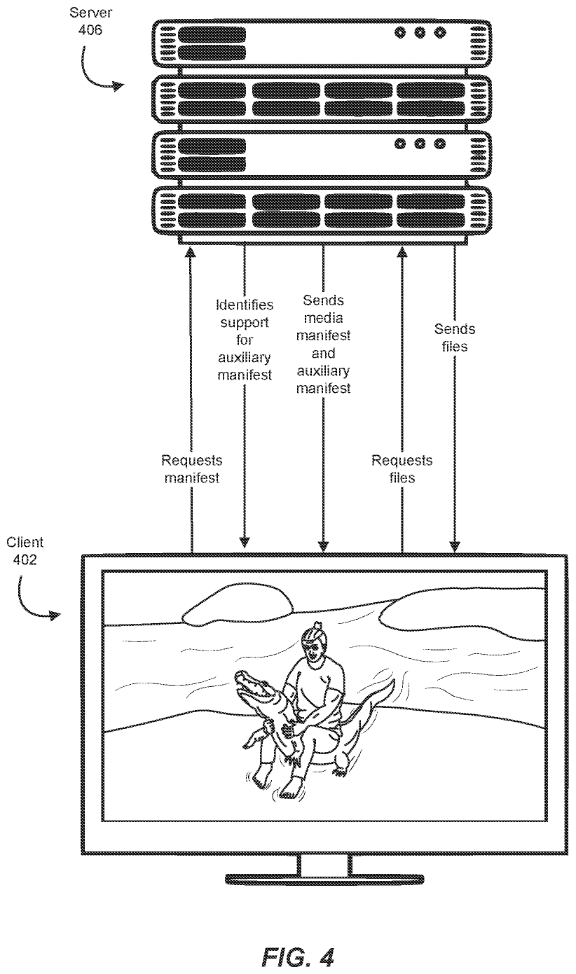

In some embodiments, the systems described herein may detect support for the auxiliary manifest before sending the auxiliary manifest. For example, as illustrated in FIG. 4, a client 402 may request a media manifest from a server 406. In one example, a client may request a manifest for a documentary on competitive alligator wrestling. In one example, server 406 may send the media manifest for the documentary to client 402 in response to the request. In some examples, server 406 may identify that client 402 supports auxiliary manifests. In one embodiment, server 406 may send a message querying client 402 about auxiliary manifest support. Additionally or alternatively, server 406 may detect auxiliary manifest support in a message sent by client 402. For example, client 402 may send an affirmative flag in the request for the media manifest that indicates that client 402 supports auxiliary manifests. In another example, client 402 may send information about client 402 (e.g., model information, version number, etc.) that indicates that client 402 can be expected to support auxiliary manifests.

In response to detecting that client 402 supports auxiliary manifests, server 406 may send the auxiliary manifest as well as the media manifest for the documentary on alligator wrestling. Next, client 402 may select appropriate files from either manifest and request those files from server 406. For example, client 402 may select an encoded video file at an appropriate resolution for a display surface of client 402 that is encoded by a codec with which client 402 is configured, a plug-in for a media player on client 402 that will enhance the playback of the documentary and which was not previously installed on client 402, and/or an audio file that is alternative audio for the documentary including a “making of” feature and additional interviews with the alligator wrestlers.

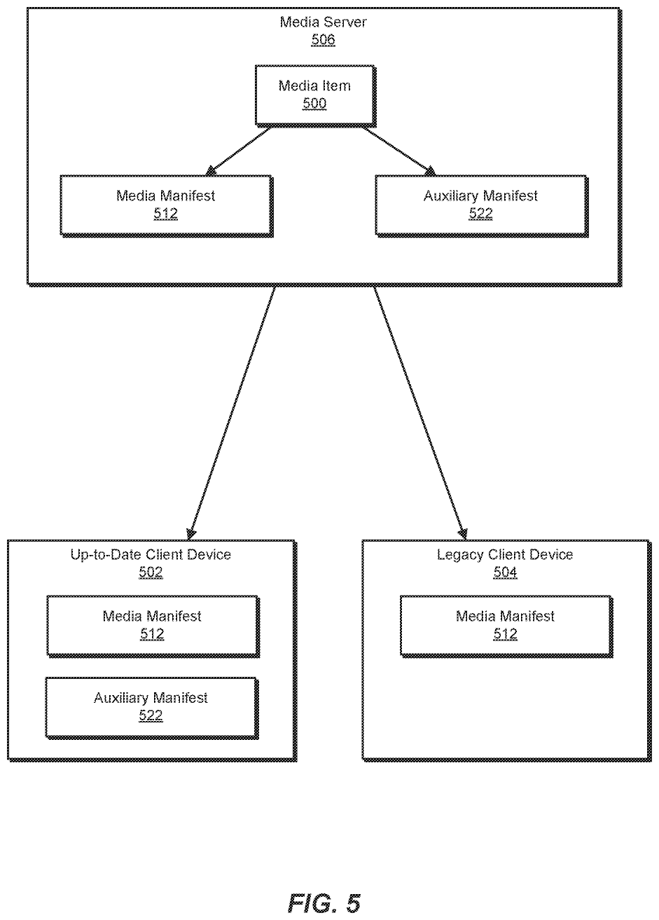

In some embodiments, the systems described herein may refrain from sending auxiliary manifests to clients that do not support auxiliary manifests. For example, as illustrated in FIG. 5, a media server 506 may host a media manifest 512 and an auxiliary manifest 522 for a media item 500. In one example, an up-to-date client device 502 may request a manifest for media item 500 and in response, server 506 may send both media manifest 512 and auxiliary manifest 522. By contrast, if a legacy client device 504 requests a manifest for media item 500, server 506 may only send media manifest 512 in order to avoid causing errors on legacy client device 504. In some embodiments, the systems described herein may decline to send an auxiliary manifest to any client that does not indicate (e.g., via requesting an auxiliary manifest, setting a flag that indicates acceptance of auxiliary manifests, sending version information that indicates a version that supports auxiliary manifests, etc.) support for auxiliary manifests.

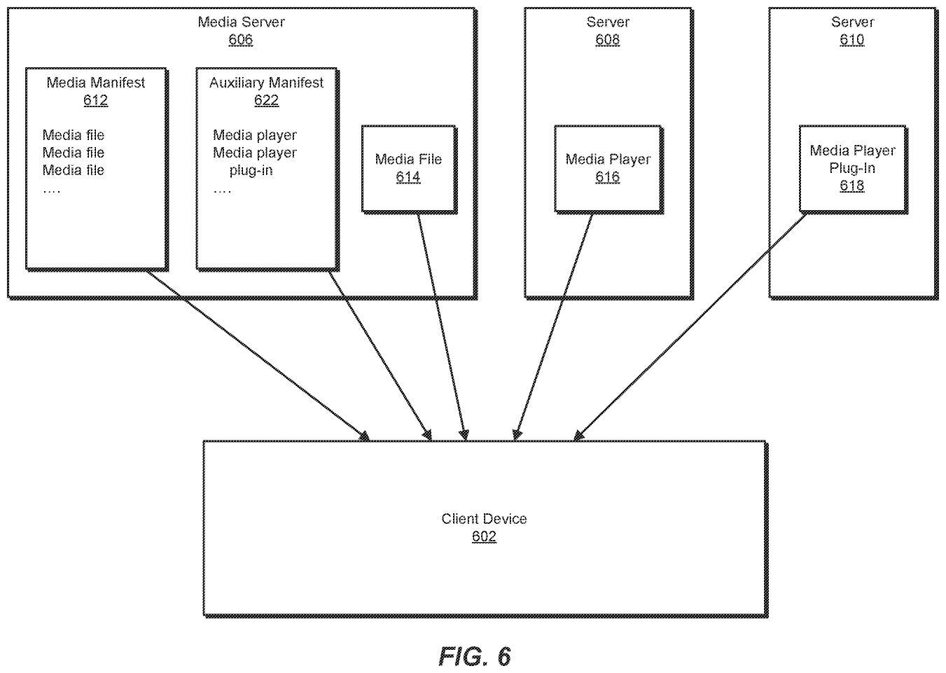

In some embodiments, the systems described herein may create an auxiliary manifest that includes non-media files that point to files stored on servers other than the server that hosts the media files. For example, an auxiliary manifest may include links to download media players, plug-ins, and/or other media-relevant files by various software publishers that are hosted on the publishers' servers. In one example, as illustrated in FIG. 6, a client device 602 may request and receive a media manifest 612 and an auxiliary manifest 622 from a media server 606. In one example, media manifest 612 may list a media file 614 that is also hosted on media server 606 while auxiliary manifest 622 may list a link to download a media player 616 that is hosted on a server 608 and/or a link to download a media player plug-in 618 that is hosted on a server 610.

In some examples, the systems described herein may facilitate the playing of a media item via an application that is not traditionally used as a media player. For example, an auxiliary manifest may list model positioning data that can be used by a rendering engine to recreate the positions of models over periods of time and display those positions as a video. In one example, a client may request a media item that is a recording of a game from an esports tournament. A video file of the recording may have a large file size. However, model position data that describes where each model was in the game environment at each time point may be comparatively small. In some examples, a client device equipped with the game engine may be able to recreate the recording based on the model position data.

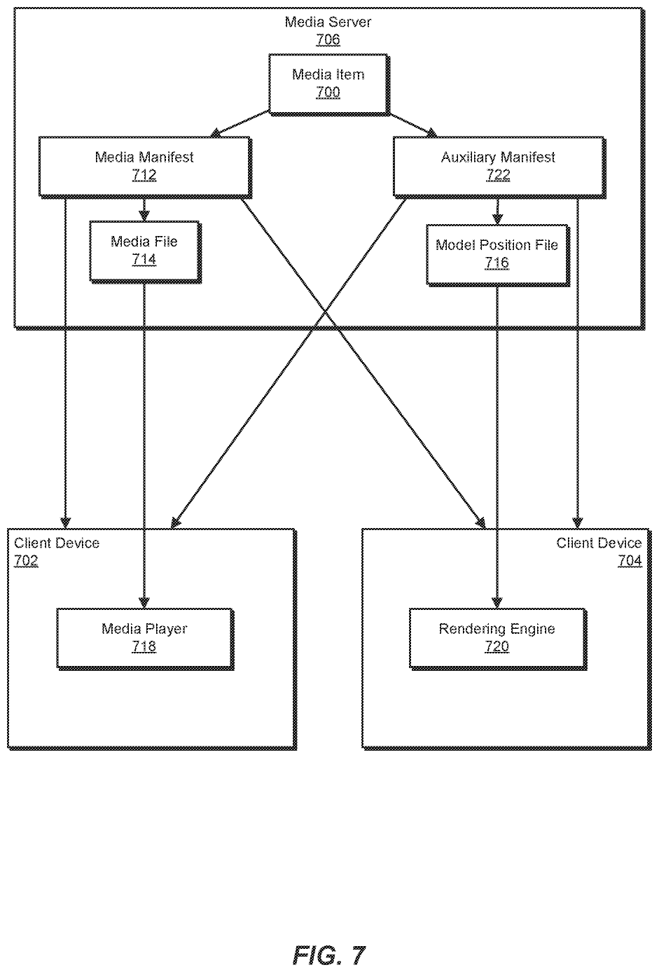

In some examples, the systems described herein may offer both traditional video files and model position data for the same media item. For example, as illustrated in FIG. 7, a media server 706 may host a media manifest 712 that lists a media file 714 for media item 700 and an auxiliary manifest 722 that lists a model position file 716 for media item 700. A client device 702 may request media manifest 712 and may receive media manifest 712 and/or auxiliary manifest 722 and then, due to not being configured with an appropriate rendering engine, may request media file 714 (e.g., to be played via a media player 718) rather than model position file 716. However, a client device 704 that is configured with a rendering engine 720 may request model position file 716 and use rendering engine 720 to reconstruct the media item.

As described above, the systems and methods described herein may improve the ability of client devices to play media items by creating auxiliary manifests that include non-media files, such as media players, media player enhancements, model positioning data, and other relevant files, and sending these auxiliary manifests alongside media manifests to clients that support them. Creating auxiliary manifests that list non-media files may improve the field of streaming video as a whole by improving the versatility and quality of streaming video without being delayed by slow updates to or adoption of new manifest standards for media manifests. By declining the send auxiliary manifests to legacy clients, the systems described herein may enable up-to-date clients to take advantage of the features offered by auxiliary manifests without causing errors on clients that do not support non-media files in manifests.

### EXAMPLE EMBODIMENTS

Example 1: A method for providing auxiliary manifests for media items may include (i) generating a media manifest for a media item that lists at least one media file that, when played by a media player, plays the media item, (ii) generating an auxiliary manifest for the media item that lists at least one non-media file that cannot be played by the media player to play the media item but facilitates playing the media item, (iii) receiving a request from a client device for the media manifest, and (iv) in response to receiving the request, sending, to the client device, both the media manifest and the auxiliary manifest.

Example 2: The computer-implemented method of example 1, where generating the media manifest includes generating the media manifest according to a manifest standard that specifies types of files to be listed in the media manifest, where the types of files includes media files and does not include non-media files.

Example 3: The computer-implemented method of examples 1-2, where generating the auxiliary manifest includes identifying a set of files relevant to the media item that are excluded by the manifest standard and listing the set of files in the auxiliary manifest.

Example 4: The computer-implemented method of examples 1-3 may further include receiving a request from an additional client device for the media manifest, determining that the additional client device is a legacy client device that does not support auxiliary manifests, and sending, to the additional client device, the media manifest while declining to send the auxiliary manifest in response to determining that the additional client device is the legacy client device.

Example 5: The computer-implemented method of examples 1-4, where sending, to the client device, both the media manifest and the auxiliary manifest includes determining that the client device supports auxiliary manifests and sending the auxiliary manifest in response to determining that the client device supports auxiliary manifests.

Example 6: The computer-implemented method of examples 1-5, where the auxiliary manifest includes a separate file from the media manifest.

Example 7: The computer-implemented method of examples 1-6, where the non-media file includes installation instructions for a media player that is not currently installed on the client device and that is capable of playing the media file.

Example 8: The computer-implemented method of examples 1-7, where the non-media file includes an updated version of the media player on the client device that enhances playback of the media file.

Example 9: The computer-implemented method of examples 1-8, where the non-media file includes a plug-in for the media player on the client device that enhances playback of the media file.

Example 10: The computer-implemented method of examples 1-9, where the non-media file includes a post-processing filter to be applied to the media file by the client device.

Example 11: The computer-implemented method of examples 1-10, where the non-media file includes machine learning model training data that enhances playback of the media file on the client device.

Example 12: The computer-implemented method of examples 1-11, where the non-media file includes a decode complexity metric for the media file.

Example 13: The computer-implemented method of examples 1-12, where the non-media file includes projection data for a three-dimensional version of the media item.

Example 14: The computer-implemented method of examples 1-13, where the non-media file includes model position data for a rendering engine on the client device that is capable of rendering visuals based on the model position data.

Example 15: The computer-implemented method of examples 1-14, where the non-media file includes a codec capable of decoding the media file.

Example 16: A system for providing auxiliary manifests for media items may include at least one physical processor and physical memory including computer-executable instructions that, when executed by the physical processor, cause the physical processor to (i) generate a media manifest for a media item that lists at least one media file that, when played by a media player, plays the media item, (ii) generate an auxiliary manifest for the media item that lists at least one non-media file that cannot be played by the media player to play the media item but facilitates playing the media item, (iii) receive a request from a client device for the media manifest, and (iv) in response to receiving the request, send, to the client device, both the media manifest and the auxiliary manifest.

Example 17: The system of example 16, where generating the media manifest includes generating the media manifest according to a manifest standard that specifies types of files to be listed in the media manifest, where the types of files includes media files and does not include non-media files.

Example 18: The system of examples 16-17, where generating the auxiliary manifest includes identifying a set of files relevant to the media item that are excluded by the manifest standard and listing the set of files in the auxiliary manifest.

Example 19: The system of examples 16-18, where sending, to the client device, both the media manifest and the auxiliary manifest includes determining that the client device supports auxiliary manifests and sending the auxiliary manifest in response to determining that the client device supports auxiliary manifests.

Example 20: A non-transitory computer-readable medium may include one or more computer-readable instructions that, when executed by at least one processor of a computing device, cause the computing device to (i) generate a media manifest for a media item that lists at least one media file that, when played by a media player, plays the media item, (ii) generate an auxiliary manifest for the media item that lists at least one non-media file that cannot be played by the media player to play the media item but facilitates playing the media item, (iii) receive a request from a client device for the media manifest, and (iv) in response to receiving the request, send, to the client device, both the media manifest and the auxiliary manifest.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
generating a media manifest for a media item that lists at least one media file that, when played by a media player, plays the media item;
generating an auxiliary manifest for the media item that lists at least one non-media file that cannot be played by the media player to play the media item but facilitates playing the media item;
receiving a request from a client device for the media manifest; and
in response to receiving the request, sending, to the client device, both the media manifest and the auxiliary manifest.

2. The computer-implemented method of claim 1, wherein generating the media manifest comprises generating the media manifest according to a manifest standard that specifies types of files to be listed in the media manifest, wherein the types of files comprises media files and does not comprise non-media files.

3. The computer-implemented method of claim 2, wherein generating the auxiliary manifest comprises:
identifying a set of files relevant to the media item that are excluded by the manifest standard; and
listing the set of files in the auxiliary manifest.

4. The computer-implemented method of claim 1, further comprising:
receiving a request from an additional client device for the media manifest;
determining that the additional client device is a legacy client device that does not support auxiliary manifests; and
sending, to the additional client device, the media manifest while declining to send the auxiliary manifest in response to determining that the additional client device is the legacy client device.

5. The computer-implemented method of claim 1, wherein sending, to the client device, both the media manifest and the auxiliary manifest comprises:
determining that the client device supports auxiliary manifests; and
sending the auxiliary manifest in response to determining that the client device supports auxiliary manifests.

6. The computer-implemented method of claim 1, wherein the auxiliary manifest comprises a separate file from the media manifest.

7. The computer-implemented method of claim 1, wherein the non-media file comprises installation instructions for a media player that is not currently installed on the client device and that is capable of playing the media file.

8. The computer-implemented method of claim 1, wherein the non-media file comprises an updated version of the media player on the client device that enhances playback of the media file.

9. The computer-implemented method of claim 1, wherein the non-media file comprises a plug-in for the media player on the client device that enhances playback of the media file.

10. The computer-implemented method of claim 1, wherein the non-media file comprises a post-processing filter to be applied to the media file by the client device.

11. The computer-implemented method of claim 1, wherein the non-media file comprises machine learning model training data that enhances playback of the media file on the client device.

12. The computer-implemented method of claim 1, wherein the non-media file comprises a decode complexity metric for the media file.

13. The computer-implemented method of claim 1, wherein the non-media file comprises projection data for a three-dimensional version of the media item.

14. The computer-implemented method of claim 1, wherein the non-media file comprises model position data for a rendering engine on the client device that is capable of rendering visuals based on the model position data.

15. The computer-implemented method of claim 1, wherein the non-media file comprises a codec capable of decoding the media file.

16. A system comprising:
at least one physical processor;
physical memory comprising computer-executable instructions that, when executed by the physical processor, cause the physical processor to:
generate a media manifest for a media item that lists at least one media file that, when played by a media player, plays the media item;
generate an auxiliary manifest for the media item that lists at least one non-media file that cannot be played by the media player to play the media item but facilitates playing the media item;
receive a request from a client device for the media manifest; and
in response to receiving the request, send, to the client device, both the media manifest and the auxiliary manifest.

17. The system of claim 16, wherein generating the media manifest comprises generating the media manifest according to a manifest standard that specifies types of files to be listed in the media manifest, wherein the types of files comprises media files and does not comprise non-media files.

18. The system of claim 17, wherein generating the auxiliary manifest comprises:
identifying a set of files relevant to the media item that are excluded by the manifest standard; and
listing the set of files in the auxiliary manifest.

19. The system of claim 16, further comprising wherein sending, to the client device, both the media manifest and the auxiliary manifest comprises:
determining that the client device supports auxiliary manifests; and
sending the auxiliary manifest in response to determining that the client device supports auxiliary manifests.

20. A non-transitory computer-readable medium comprising one or more computer-readable instructions that, when executed by at least one processor of a computing device, cause the computing device to:
generate a media manifest for a media item that lists at least one media file that, when played by a media player, plays the media item;
generate an auxiliary manifest for the media item that lists at least one non-media file that cannot be played by the media player to play the media item but facilitates playing the media item;
receive a request from a client device for the media manifest; and
in response to receiving the request, send, to the client device, both the media manifest and the auxiliary manifest.
